(19) United States
(12) Patent Application Publication
(10) Pub. No.: US 2013/0156250 A1
(43) Pub. Date: Jun. 20, 2013

(54) MOUNTABLE MULTI-DIRECTIONAL AUDIO DEVICE

(71) Applicants: Yueh-Hua HSU HUANG, New Taipei City (TW); Wen-Chuan Hsu, New Taipei City (TW); Chun-Ti Chen, New Taipei City (TW)

(72) Inventors: Yueh-Hua HSU HUANG, New Taipei City (TW); Wen-Chuan Hsu, New Taipei City (TW); Chun-Ti Chen, New Taipei City (TW)

(21) Appl. No.: 13/326,630

(22) Filed: Dec. 15, 2011

(51) Int. Cl. H04R 1/02

(52) U.S. Cl. 381/385

(57) ABSTRACT

A mountable multi-directional audio device comprises at least one broadcasting device, which has a sounding portion outwardly; and at least one connecting member, the any end of the connecting member is connected with the broadcasting device.

### BACKGROUND OF THE INVENTION

1. Field of the Invention

The present invention is a mountable multi-directional audio device, more particularly to an audio device that is worn on the body of an operator.

2. Description of the Prior Art

Nowadays, a general earphone broadcasts sound from the internal thereof to surrounding should be through the internal speakers, and earphone has two types of ear wearing and head wearing. Ear wearing earphone is worn on the outline of an ear directly, but it is very close to the ear tympanum, and the soft tissue in the ear may be damaged while in a long-term wearing;

Above ear wearing and head wearing types of earphones both have advantages and disadvantages. Since the sound exits thereof are directly toward ears, the ears are then covered to cause that an operator cannot concentrate his mind, therefore any happening around him being not aware will bring him into a dangerous situation, even happening an accident.

On the other hand, general audio device may not be worn on a human body due to its volume and weight, so it can not figure out the earphone problems.

Therefore, creating an audio device that is worn on the body of the operator, lets the operator hears sound smoothly and do not cover on the ears to avoid accident is the best solution for prior arts.

### SUMMARY OF THE INVENTION

The main objective of the present invention is to provide a mountable multi-directional audio device, which is worn on the head, neck and shoulders of an operator, so as to avoid the disadvantages of not able to carry-on, damaging ears in a long-time wearing or attention is not centralized situation.

To approach objective, the mountable multi-directional audio device comprises at least one broadcasting device 11 and one connecting member 12, the any end of the connecting member 12 is connected with the broadcasting device 11, the broadcasting device 11 has a sounding portion 1111, the sounding portion 1111 is disposed a dismantled baffle plate or un-dismantled baffle plate 112, at least one sound exit 113, which lets the sounding portion 1111 emit sound, is disposed between the side of the baffle plate 112 and the sounding portion 1111.

Practically, the broadcasting device 11 has a sounding portion 1111 outwardly or inwardly.

Practically, the broadcasting device 11 has at least one speaker 111 inside.

Practically, the sounding portion 1111 of the broadcasting device 11 is disposed a dismantled baffle plate or un-dismantled baffle plate 112, at least one sound exit 113, which lets the sounding portion 1111 emit sound, is disposed between the side of the baffle plate 112 and the sounding portion 1111.

Practically, the surface of the broadcasting device 11 is added a case, the surface of the connecting member 12 is added a case.

Practically, the connecting member 12 has a folding structure 121 in order to let the broadcasting device 11, extended from the connecting member 12, be folded and a folding angle of the broadcasting device 11 be adjusted.

Practically, an adjusting mechanism is disposed between the connecting member 12 and the broadcasting device 11 in order to let the broadcasting device 11 be turned toward different directions and positioned.

Practically, a stretching mechanism 14 is disposed between the connecting member 12 and the broadcasting device 11 in order to let the length between the connecting member 12 and the broadcasting device 11 be variable.

Practically, the mountable multi-directional audio device further comprises a sound box, an amplifier and a power management device inside.

Practically, the mountable multi-directional audio device further accommodates a battery internally.

Practically, the mountable multi-directional audio device further accommodates a wired or wireless sound signal receiving device internally.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a schematic 3-D structural view of a first preferred embodiment of the mountable multi-directional audio device of the present invention;

FIG. 1B illustrates a schematic folding view of the first preferred embodiment of the mountable multi-directional audio device of the present invention;

FIG. 2A illustrates a schematic assemble view of a broadcasting device of the mountable multi-directional audio device of the present invention;

FIG. 2B illustrates a schematic dismantling view of the broadcasting device of the mountable multi-directional audio device of the present invention;

FIG. 3A illustrates a schematic sectional view of the broadcasting device of the first preferred embodiment of the mountable multi-directional audio device of the present invention;

FIG. 3B illustrates a schematic sounding view of the broadcasting device of the first preferred embodiment of the mountable multi-directional audio device of the present invention;

FIG. 4 illustrates a schematic application view of the first preferred embodiment of the mountable multi-directional audio device of the present invention;

FIG. 5 illustrates a schematic application view of the first preferred embodiment of the mountable multi-directional audio device of the present invention;

FIG. 6A illustrates a schematic 3-D structural view of a second preferred embodiment of the mountable multi-directional audio device of the present invention;

FIG. 6B illustrates a schematic folding view of the second preferred embodiment of the mountable multi-directional audio device of the present invention;

FIG. 7 illustrates a schematic sectional view of the broadcasting device of the second preferred embodiment of the mountable multi-directional audio device of the present invention;

FIG. 8 illustrates a schematic application view of the second preferred embodiment of the mountable multi-directional audio device of the present invention;

FIG. 9A illustrates a schematic 3-D structural view of a third preferred embodiment of the mountable multi-directional audio device of the present invention;

FIG. 9B illustrates a schematic folding view of the third preferred embodiment of the mountable multi-directional audio device of the present invention;

FIG. 10A illustrates a schematic sectional view of the broadcasting to device of the third preferred embodiment of the mountable multi-directional audio device of the present invention;

FIG. 10B illustrates a schematic sounding view of the broadcasting device of the third preferred embodiment of the mountable multi-directional audio device of the present invention;

FIG. 11 illustrates a schematic application view of the third preferred embodiment of the mountable multi-directional audio device of the present invention;

FIG. 12 illustrates a schematic 3-D structural view of a fourth preferred embodiment of the mountable multi-directional audio device of the present invention;

FIG. 13 illustrates a schematic sectional view of the broadcasting device of the fourth preferred embodiment of the mountable multi-directional audio device of the present invention;

FIG. 14 illustrates a schematic application view of the fourth preferred embodiment of the mountable multi-directional audio device of the present invention;

FIG. 15 illustrates a schematic rotation view of a fifth preferred embodiment of the mountable multi-directional audio device of the present invention; and

FIG. 16 illustrates a schematic extending view of a sixth preferred embodiment of the mountable multi-directional audio device of the present invention

### DETAILED DESCRIPTION OF THE INVENTION

Following preferred embodiments and figures will be described in detail so as to achieve aforesaid objects.

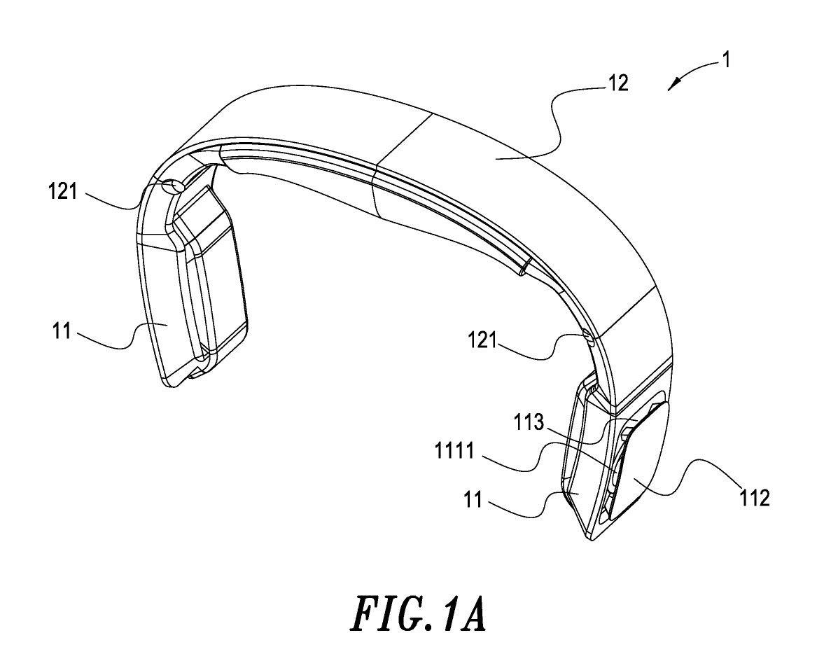

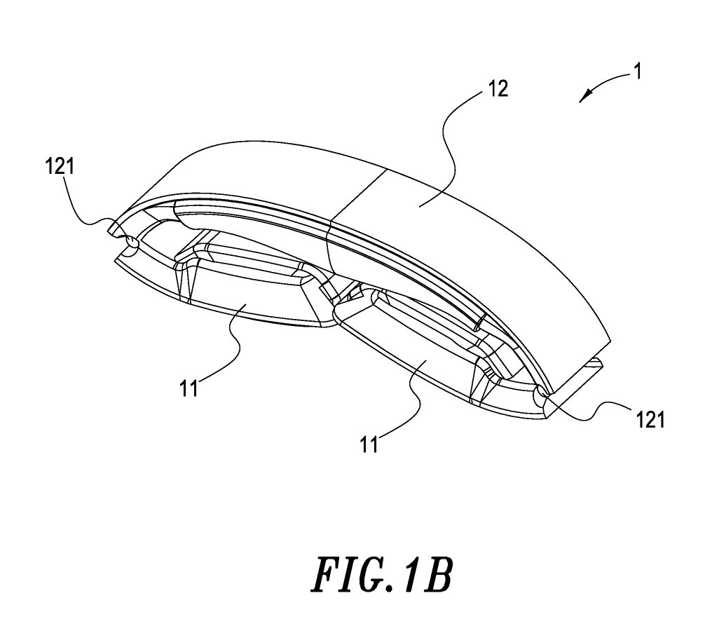

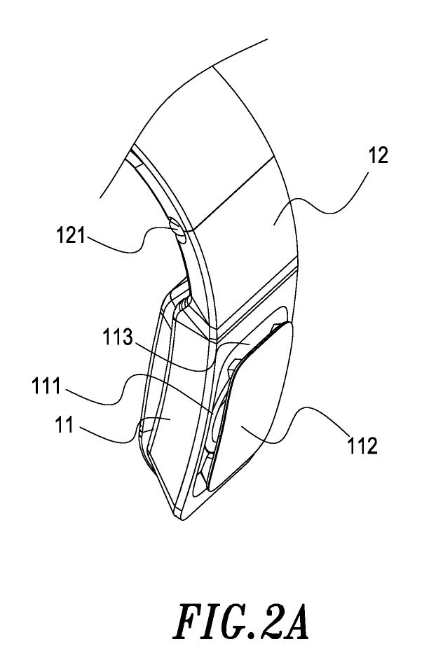

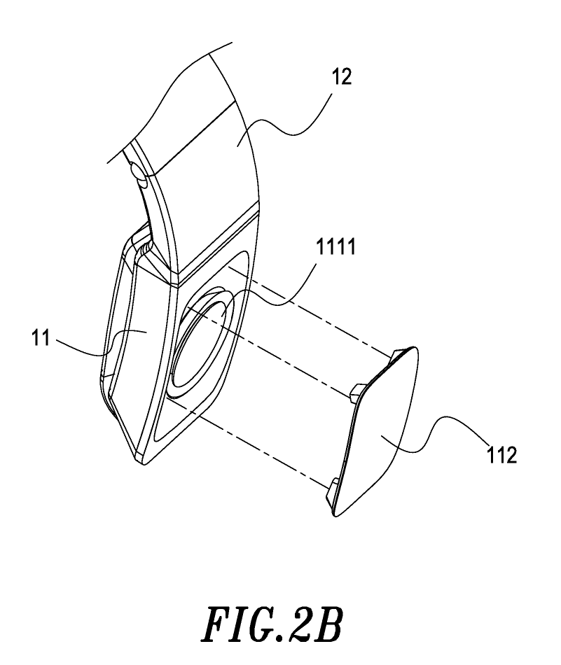

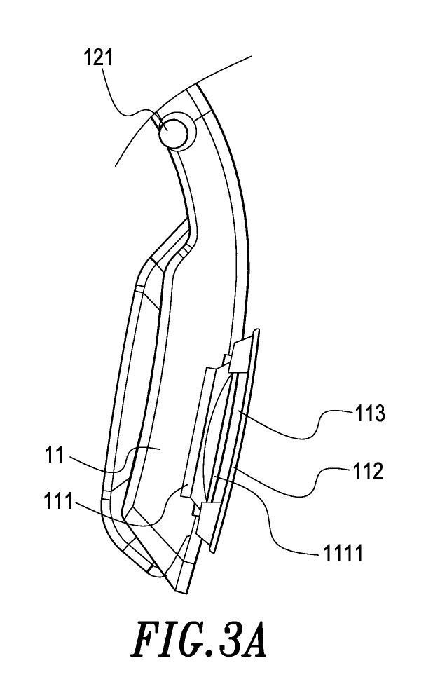

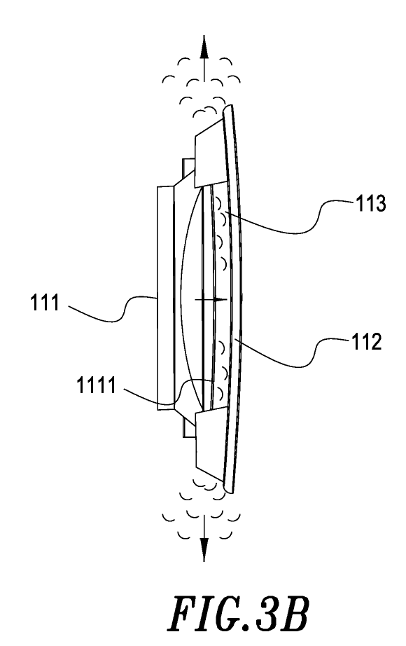

With references to FIG. 1A and FIG. 1B, which illustrate a schematic 3-D structural view of a first preferred embodiment of the mountable multi-directional audio device of the present invention and a schematic folding view of the first preferred embodiment of the mountable multi-directional audio device of the present invention. As shown in figures, the mountable multi-directional audio device 1 has two broadcasting devices and one connecting member 12, wherein the two ends of the connecting member 12 are extendable to connect with the broadcasting devices 11, the broadcasting device 11 has at least one speaker 111 inside. As shown in FIG. 3A, the broadcasting device 11 has a sounding portion 1111 outwardly, in addition, the sounding portion 1111 is disposed a baffle plate 112, which is dismantled or un-dismantled. As shown in FIG. 2A and FIG. 2B, at least one sound exit 113 is disposed between the side of the baffle plate 112 and the sounding portion 1111, the sound from the sounding portion 1111 will be emitted through the sound exit 113 while the sounding portion 1111 of the speaker 111 is sounding, as shown in FIG. 3B.

Additionally, the connecting member 12 has a folding structure 121 in order to let the broadcasting device 11, extended from the connecting member 12, be folded and a folding angle of the broadcasting device 11 be adjusted for each side of the mountable multi-directional audio device 1, so that the mountable multi-directional audio device 1 is able to place on a plain surface.

More, the surface of the broadcasting device 11 is added a case, not shown in figure, the surface of the connecting member 12 is added a case, not shown in figure. Each side of the mountable multi-directional audio device 1 further comprises a sound box, an amplifier and a power management device inside, not shown in figure, a battery or wireless device can be optionally adapted, wherein the amplifier is connected with the broadcasting device 11, so that the mountable multi-directional audio device 1 is integrated.

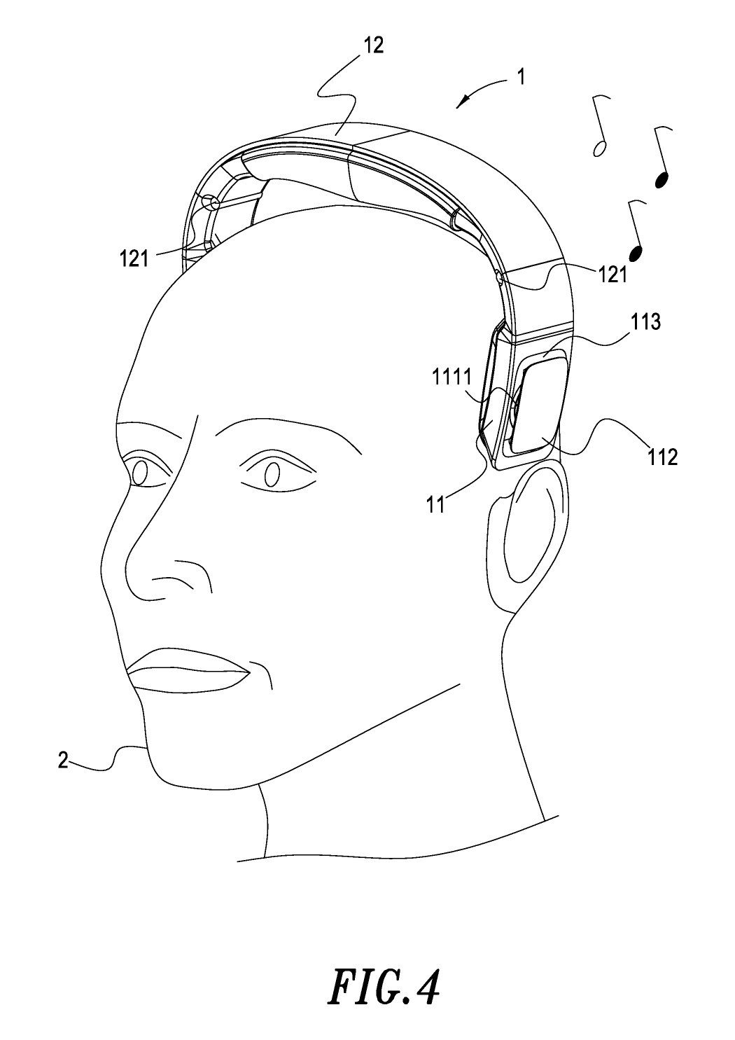

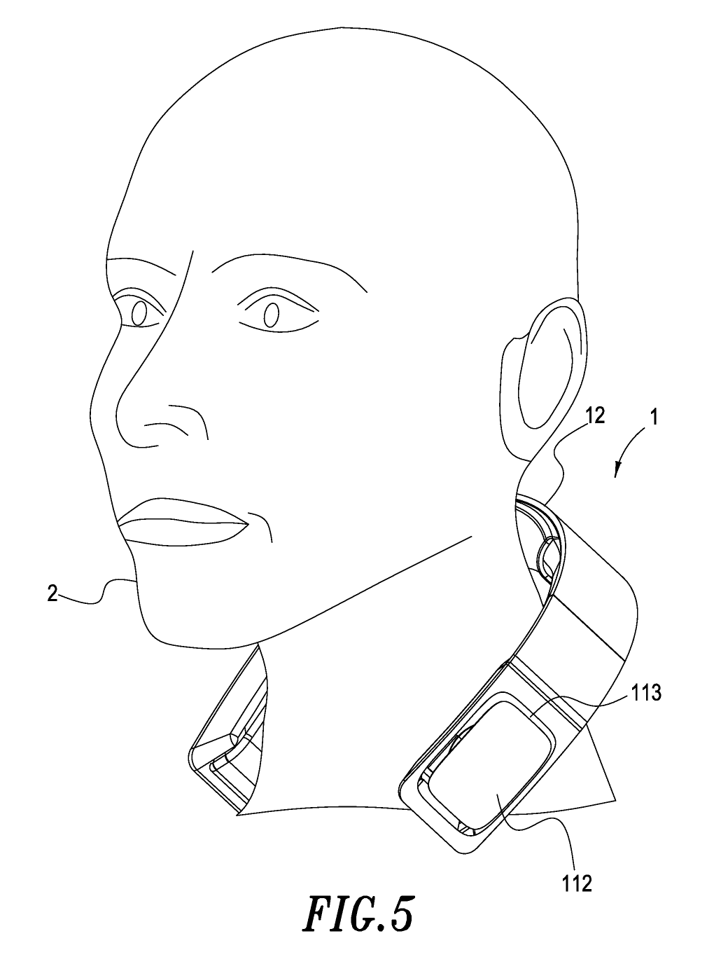

As shown in FIG. 4, while an operator 2 wears the mountable multi-directional audio device 1 above the ears himself, sound from the sounding portion 1111 may be blocked by the dismantled baffle plate or un-dismantled baffle plate 112, and consequently the sound may be emitted toward surrounding through the sound exits 113. Hence, there is no necessary to position the sound portions 1111 toward the ears of the operator 2, the sound from the sounding portions 1111 of the speakers 111 is still heard. The present invention is not only worn on the head of the operator 2, but also the neck or shoulders himself. As shown in FIG. 5, the mountable multi-directional audio device is worn on the neck of the operator 2.

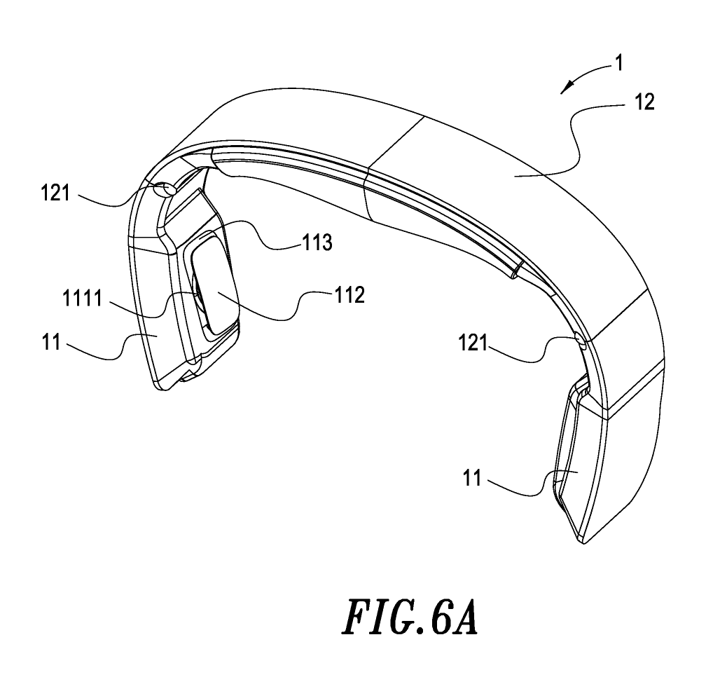

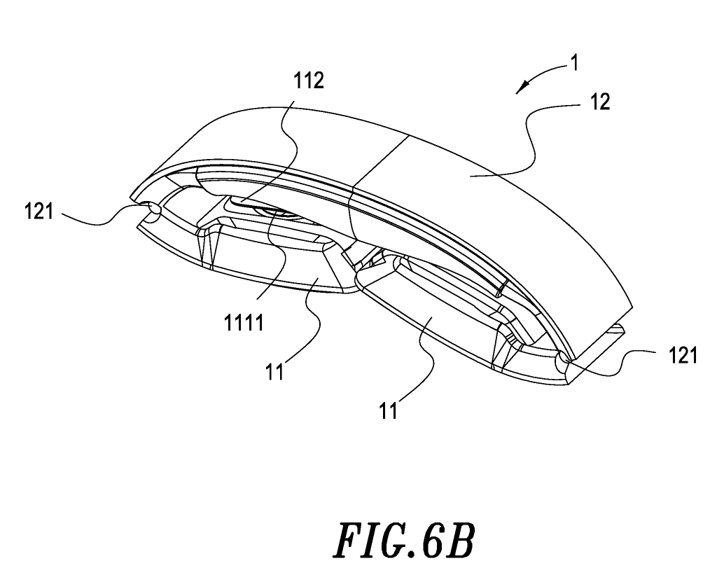

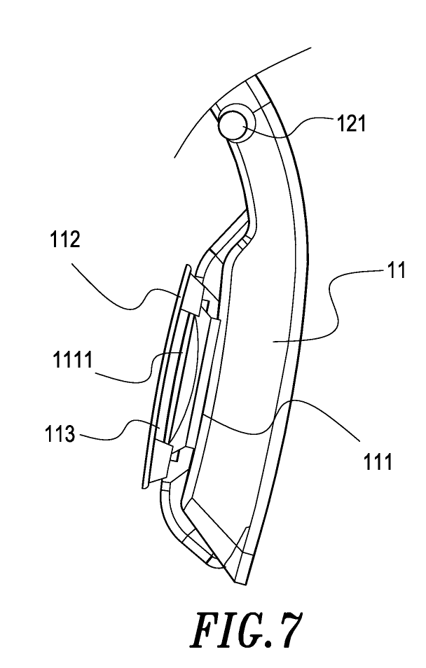

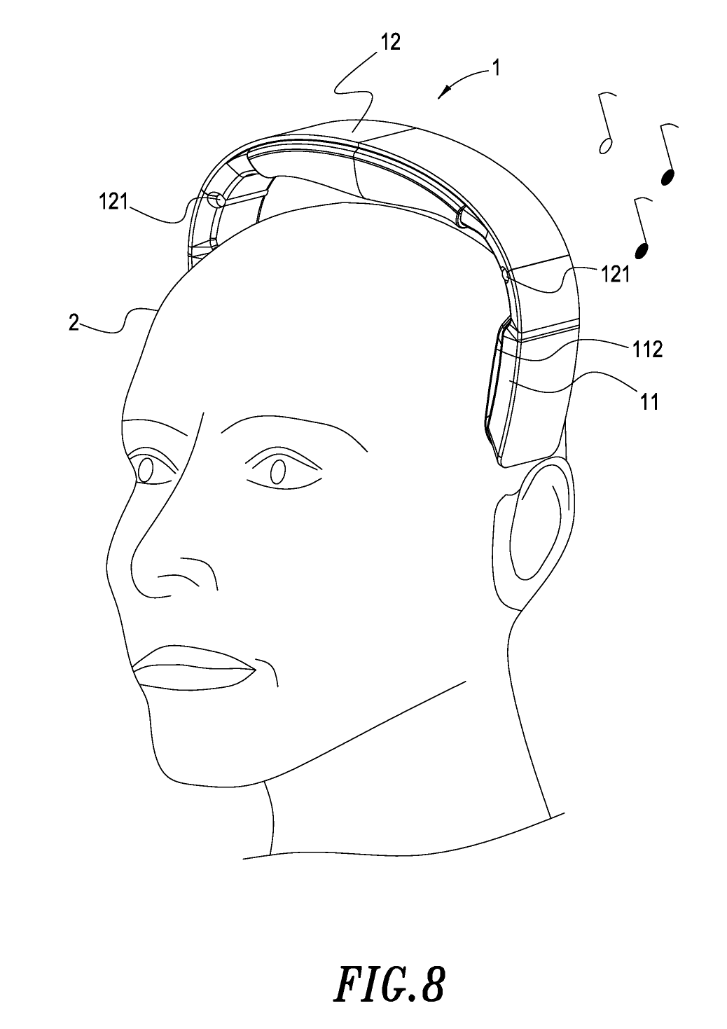

Except for disposing the sounding portion 1111 on the broadcasting device 11 outside, the broadcasting device may have the sounding portion 1111 inwardly as well. As shown in FIG. 6A and FIG. 6B, which illustrate a schematic 3-D structural view of a second preferred embodiment of the mountable multi-directional audio device of the present invention and a schematic folding view of the second preferred embodiment of the mountable multi-directional audio device of the present invention. The theory of the second preferred embodiment is the same as the first preferred embodiment. The only difference is that the sounding portion 1111 of the speaker 111 is disposed at the inner surface of the broadcasting device 11, as shown in FIG. 7. Hence, the sound from the sound portions 1111 is spread to the inner side of the broadcasting device 11 and goes out through the sound exits 113, therefore there is no necessary to position the sounding portions 1111 toward the ears of the operator, the sound from the sounding portions 1111 of the speaker 111 is still heard, as shown in FIG. 8.

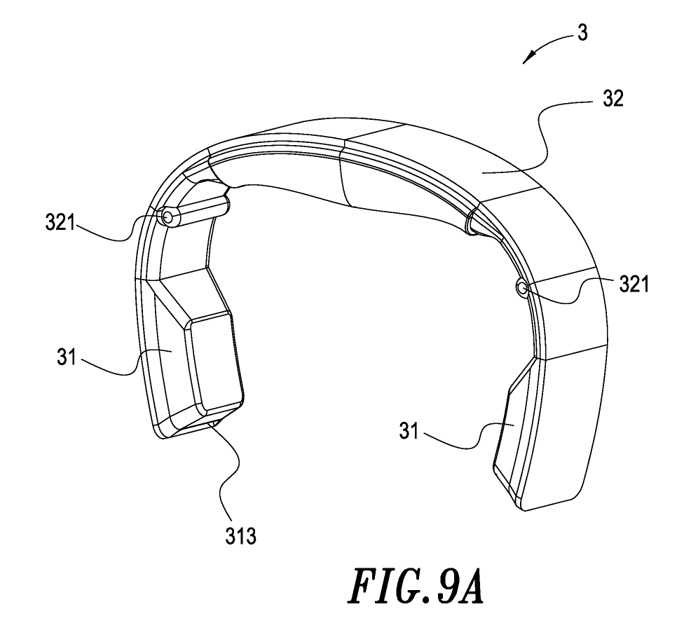

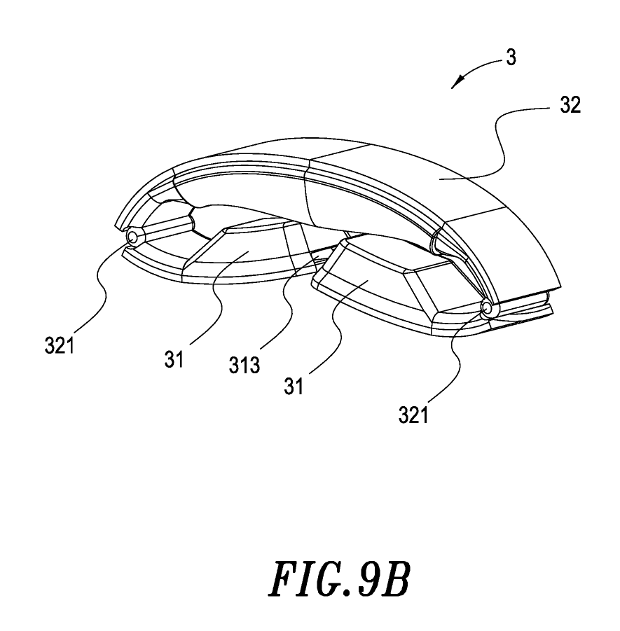

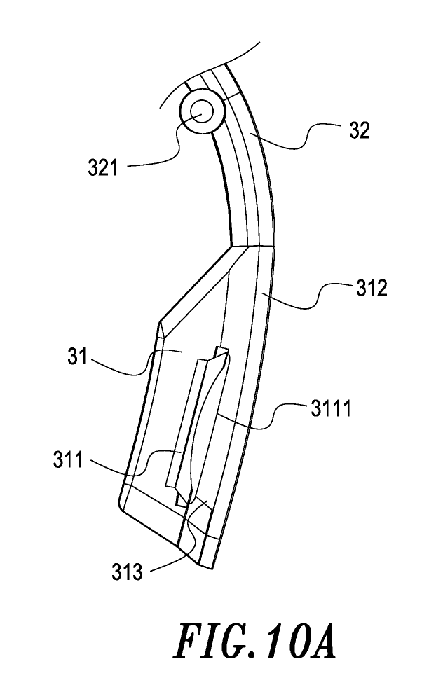

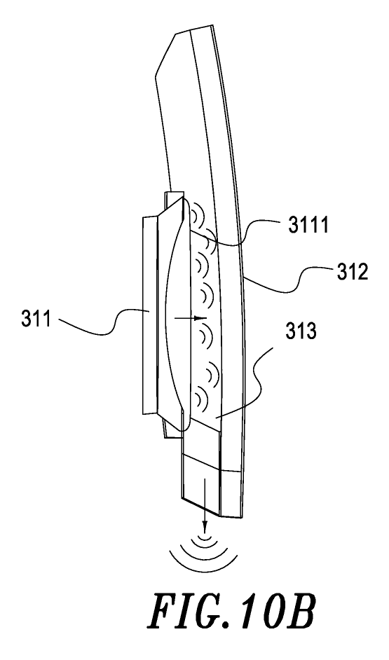

Other than the first preferred embodiment and the second preferred embodiment, the mountable multi-directional audio device 3 could have only a downward sound exit 313 between the side of the dismantled or un-dismantled baffle plate 312 and the sounding portion 3111. As shown in FIG. 9A and FIG. 9B, which point out a third preferred embodiment. The mountable multi-directional audio device 3 has two broadcasting devices 31 and one connecting member 32, the two ends of the connecting member 32 are connected with the broadcasting device 31, the broadcasting device 31 has at least one speaker 311 inside. As shown in FIG. 10A, the broadcasting device 31 has a sounding portion 3111 outwardly, the sounding portion 3111 of the broadcasting device 31 is disposed a dismantled baffle plate or un-dismantled baffle plate 312. As shown in FIG. 10A and FIG. 10B, the downward sound exit 313 is disposed between the side of the baffle plate 312 and the sounding portion 3111, and the sound from the sounding portion 3111 may be reflected by the baffle plate 312 and emitted toward the sound exit 313 while the sounding portion 3111 is sounding, as shown in FIG. 10B.

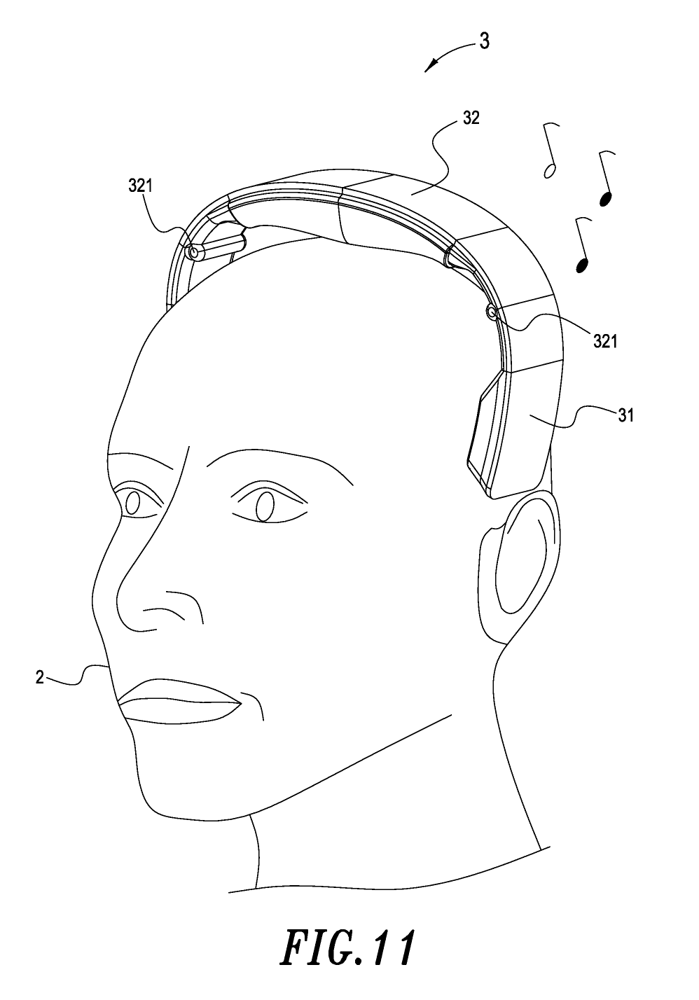

As shown in FIG. 11, while an operator 2 wears the mountable multi-directional audio device 3 above the ears himself, sound from the sounding portion 3111 may be reflected by the baffle plate 312, and consequently the sound may be emitted toward surrounding through the sound exits 313. Hence, there is no necessary to position the sound portions 3111 toward the ears of the operator 2, the sound from the sounding portions 3111 of the speakers 311 is still heard.

More, the surface of the broadcasting device 31 is added a case, not shown in figure, the surface of the connecting member 32 is added a case, not shown in figure. Each side of the mountable multi-directional audio device 3 further comprises a sound box, an amplifier and a power management device inside, not shown in figure, wherein the amplifier is connected with the broadcasting device 11, so that the mountable multi-directional audio device 1 is integrated. A battery or a wired or wireless sound signal receiving device can be optionally adapted by the mountable multi-directional audio device 3, not shown in figure.

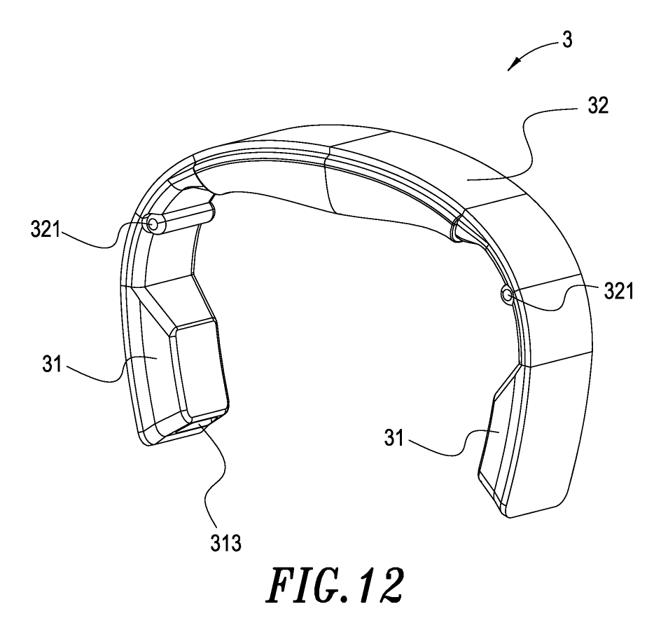

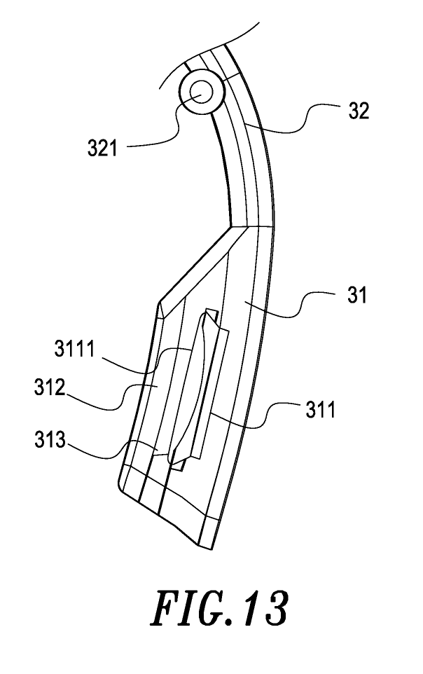

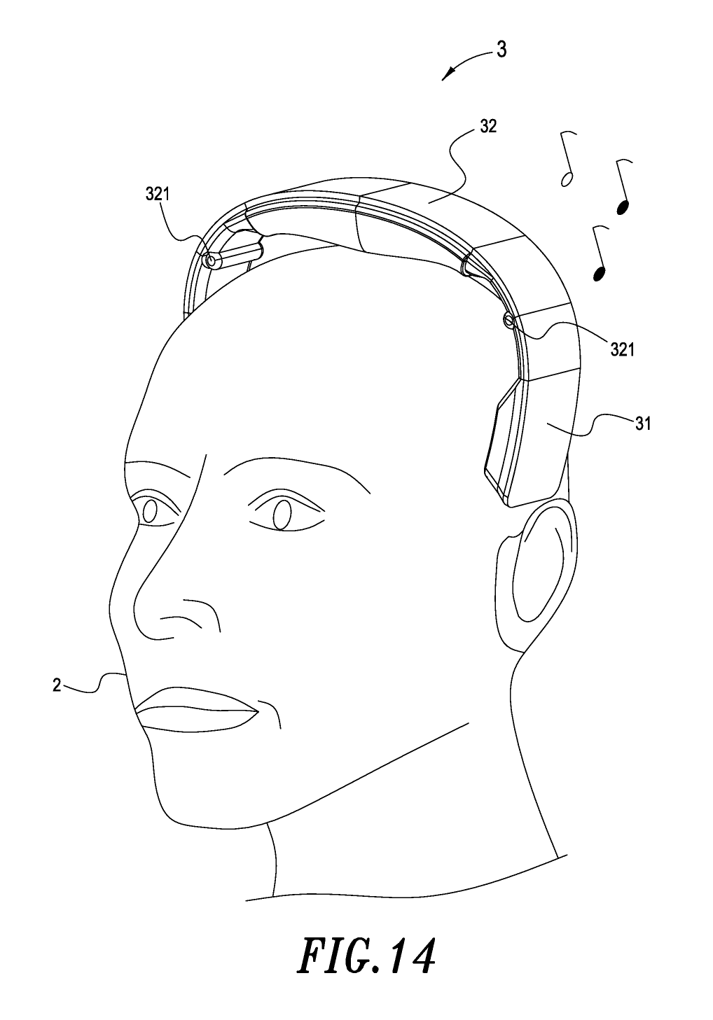

Except for disposing the sounding portion 3111 on the broadcasting device 31 outward, the broadcasting device 31 may have one sounding portion 3111 inwardly as well, as shown in FIG. 12 and FIG. 13, which illustrate a schematic structural view of a fourth preferred embodiment of the present invention and a schematic sectional view of the fourth preferred embodiment of the present invention. The theory of the fourth preferred embodiment is the same as the third preferred embodiment. The only difference is that the sounding portion 3111 of the speaker 311 is disposed inwardly, the sound exit 313 between the side of the baffle plate 312 and the sounding portion 3111 is disposed inwardly also, as shown in FIG. 13. As shown in FIG. 14, while the operator 2 wears the mountable multi-directional audio device 3 on the head himself, sound from the sounding portion 3111 may be reflected by the baffle plate 312, and consequently the sound may be emitted toward surrounding through the sound exits 313. Hence, there is no necessary to position the sound portions 3111 toward the ears of the operator 2, the sound from the sounding portions 3111 of the speakers 311 is still heard.

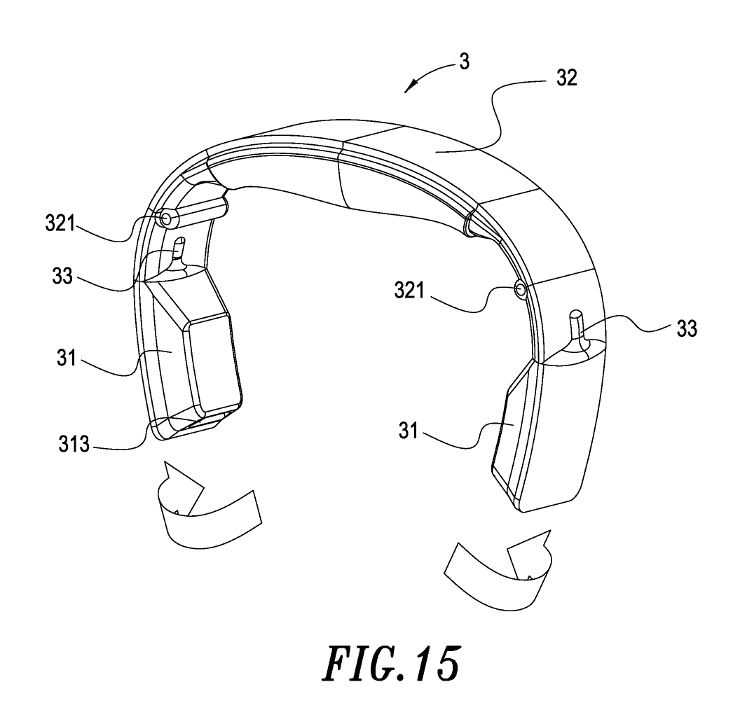

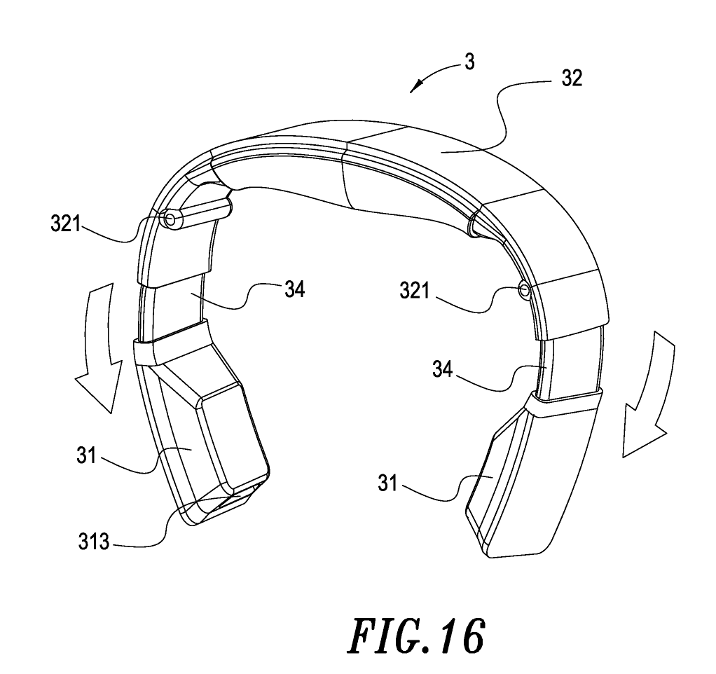

More, a rotation mechanism 33 is disposed between the connecting member 32 and the broadcasting device 31, therefore the broadcasting device 31 is capable of rotating toward different directions and positioning, as shown in FIG. 15. A stretching mechanism 34 is disposed between the connecting member 32 and the broadcasting device 11 in order to let the length between the connecting member 32 and the broadcasting device 31 be variable, as shown in FIG. 16.

Compared to prior arts, the present invention providing the mountable multi-directional audio device has following advantages listed below:
1. The mountable multi-directional audio device of the present invention is a headset audio device and able to let sound be broadcasted toward different directions so as to avoid that the operator cannot centralize his attention due to a headset.
2. The mountable multi-directional audio device of the present invention is a headset audio device and able to let sound be broadcasted toward different directions so as to make a low possibility of damaging the ears of the operator.
3. Each side of the mountable multi-directional audio device further comprises a sound box, an amplifier and a power management device inside, further that, a battery or a wired or wireless sound signal receiving device can be optionally adapted by the mountable multi-directional audio device, so that the mountable multi-directional audio device is a multi-function and integrated audio device.
4. The mountable multi-directional audio device of the present invention can be folded and carry-on.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A mountable multi-directional audio device comprising at least one broadcasting device 11 and one connecting member 12, wherein the any end of the connecting member 12 is connected with the broadcasting device 11.

2. A mountable multi-directional audio device comprising:
at least one broadcasting device 11, which has a sounding portion 1111 outwardly; and
at least one connecting member 12, the any end of the connecting member 12 being connected with the broadcasting device 11.

3. The mountable multi-directional audio device according to claim 2, wherein the broadcasting device 11 has at least one speaker 111 inside.

4. The mountable multi-directional audio device according to claim 2, wherein the sounding portion 1111 of the broadcasting device 11 is disposed a dismantled baffle plate or un-dismantled baffle plate 112.

5. The mountable multi-directional audio device according to claim 4, wherein at least one sound exit 113, which lets the sounding portion 1111 emit sound, is disposed between the side of the baffle plate 112 and the sounding portion 1111.

6. The mountable multi-directional audio device according to claim 2, wherein the surface of the broadcasting device 11 is added a case.

7. The mountable multi-directional audio device according to claim 2, wherein the connecting member 12 has a folding structure 121 in order to let the broadcasting device 11, extended from the connecting member 12, be folded and a folding angle of the broadcasting device 11 be adjusted.

8. The mountable multi-directional audio device according to claim 2 further comprising a sound box, an amplifier and a power management device inside.

9. The mountable multi-directional audio device according to claim 2 accommodating a battery internally.

10. The mountable multi-directional audio device according to claim 2 accommodating a wired or wireless sound signal receiving device internally.

11. The mountable multi-directional audio device according to claim 2, wherein the surface of the connecting member 12 is added a case.

12. The mountable multi-directional audio device according to claim 2, wherein an adjusting mechanism is disposed between the connecting member 12 and the broadcasting device 11 in order to let the broadcasting device 11 be turned toward different directions and positioned.

13. The mountable multi-directional audio device according to claim 2, wherein a stretching mechanism 14 is disposed between the connecting member 12 and the broadcasting device 11 in order to let the length between the connecting member 12 and the broadcasting device 11 be variable.

14. A mountable multi-directional audio device comprising:
at least one broadcasting device 31, which has a sounding portion 3111 inwardly; and at least one connecting member 32, the any end of the connecting member 32 is connected with the broadcasting device 31.

15. The mountable multi-directional audio device according to claim 14, wherein the broadcasting device 31 has at least one speaker 311 inside.

16. The mountable multi-directional audio device according to claim 14, wherein the sounding portion 3111 of the broadcasting device 31 is disposed a dismantled baffle plate or un-dismantled baffle plate 312.

17. The mountable multi-directional audio device according to claim 16, wherein at least one sound exit 313, which lets the sounding portion 3111 emit sound, is disposed between the side of the baffle plate 312 and the sounding portion 3111.

18. The mountable multi-directional audio device according to claim 14, wherein the surface of the broadcasting device 31 is added a case.

19. The mountable multi-directional audio device according to claim 14, wherein the connecting member 32 has a folding structure 321 in order to let the broadcasting device 31, extended from the connecting member 32, be folded and an folding angle of the broadcasting device 31 be adjusted.

20. The mountable multi-directional audio device according to claim 14 further comprising a sound box, an amplifier and a power management device inside.

21. The mountable multi-directional audio device according to claim 14 accommodating a battery internally.

22. The mountable multi-directional audio device according to claim 14 accommodating a wired or wireless sound signal receiving device internally.

23. The mountable multi-directional audio device according to claim 14, wherein the surface of the connecting member 32 is added a case.

24. The mountable multi-directional audio device according to claim 14, wherein an adjusting mechanism is disposed between the connecting member 32 and the broadcasting device 31 in order to let the broadcasting device 31 be turned toward different directions and positioned.

25. The mountable multi-directional audio device according to claim 14, wherein a stretching mechanism 34 is disposed between the connecting member 32 and the broadcasting device 11 in order to let the length between the connecting member 32 and the broadcasting device 31 be variable.
